(19) United States
(12) Patent Application Publication
(10) Pub. No.: US 2006/0019757 A1
(43) Pub. Date: Jan. 26, 2006

(54) Homokinetic joint-hub unit for the wheel of a motor vehicle

(75) Inventors: Marco Brunetti, Torino (IT); Angelo Vignotto, Torino (IT); Marcus Caldana, Lidkoping (SE)

Correspondence Address: MERCHANT & GOULD PC, P.O. BOX 2903, MINNEAPOLIS, MN, 55402-0903, US

(73) Assignees: AKTIEBOLAGET SKF, Goteborg (SE); MINGANTI INTERNATIONAL LTD, Dublin (IE)

(21) Appl. No.: 11/126,883

(22) Filed: May 11, 2005

(30) Foreign Application Priority Data
May 14, 2004 (IT) TO2004A000313

(51) Int. Cl. F16C 1/26

(52) U.S. Cl. 464/178

(57) ABSTRACT

The unit comprises a homokinetic joint (1) a hub (3) which can rotate around a rotation axis (x) and has an axially projecting spindle (5), and an intermediate race (4) which is fixed onto the spindle (5) in order to rotate with the homokinetic joint and transmit a driving torque of the joint (1) to the hub (3). The intermediate race (4) and the joint (1) are coupled in such a way as to rotate together around the axis (x) by means of respective interface surfaces (26, 27) which have corresponding lobed, oval or spiral shapes on a plane which is perpendicular to the rotation axis (x).

### DESCRIPTION

The present invention relates to a homokinetic joint-hub unit for the wheel of a motor vehicle.

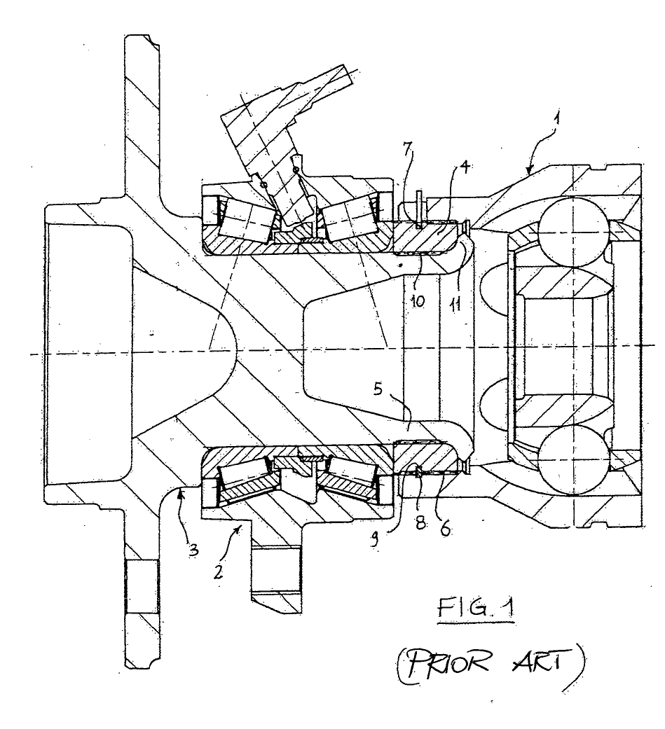

In order to provide a better understanding of the problems and technical solutions which are currently well known in relation to the coupling between a homokinetic joint and a hub of a wheel, a brief description of a unit of a traditional type will follow, with reference to FIG. 1 of the attached drawings.

With reference to FIG. 1, a wheel hub unit is shown in which a homokinetic joint 1 is coupled, in such a way that it can rotate, to a bearing-hub unit 2, 3 by means of an intermediate race 4 which is mounted on the spindle 5 of the hub. The intermediate race is coupled in order to rotate with the homokinetic joint by means of an axial toothed section of a ribbed coupling 6. An elastic race 7 which is housed in two circular throats 8, 9 formed respectively in the homokinetic joint 1 and on the intermediate race 4 axially connects the latter to the homokinetic joint. The intermediate race 4 is fixed to the spindle of the hub by means of an additional ribbed coupling 10 with the spindle and by cold plastic deformation of a border 11 of the spindle or, alternatively, by means of a line of welding.

Other examples of ribbed couplings between a homokinetic joint and a hub are described, for example, in US-6 022 275, IT-1 281 365, US-4 893 960, US-5 853 250, EP-0 852 300.

Ribbed couplings have some disadvantages in that they require precise tolerances and, however, leave undesirable levels of play, so that some of the axial teeth, due to the fact that they have to support high levels of pressure, are subject to detrimental peaks of tension. In order to eliminate the play in a circumferential direction, slightly spiral shaped teeth have been suggested, which, however, require forced coupling and are therefore more difficult to produce. In addition, the teeth are subjected to a thermal treatment which inevitably produces distortions, so that it is necessary to carry out complicated mechanical working before coupling the two ribbed parts together.

The aim of the present invention is to produce a perfected hub-homokinetic joint unit, which is capable of overcoming all the disadvantages and technical limitations which have been described above.

This and other aims and advantages, which will be better dealt with below, are included according to the present invention of a hub-homokinetic joint unit and a bearing-hub unit as described in the attached Claims. In an extremely brief summary, an intermediate race of the bearing-hub unit is coupled to the homokinetic joint in order to rotate together with the latter by means of corresponding lobed interface surfaces, preferably of an oval or spiral shape, on a plane of perpendicular section in relation to the rotation axis of the hub.

Some non-limiting forms of embodiment of the present invention will now be described, with reference to the attached drawings in which:

FIG. 1 is an axial section view of a hub-homokinetic joint unit of a well known kind;

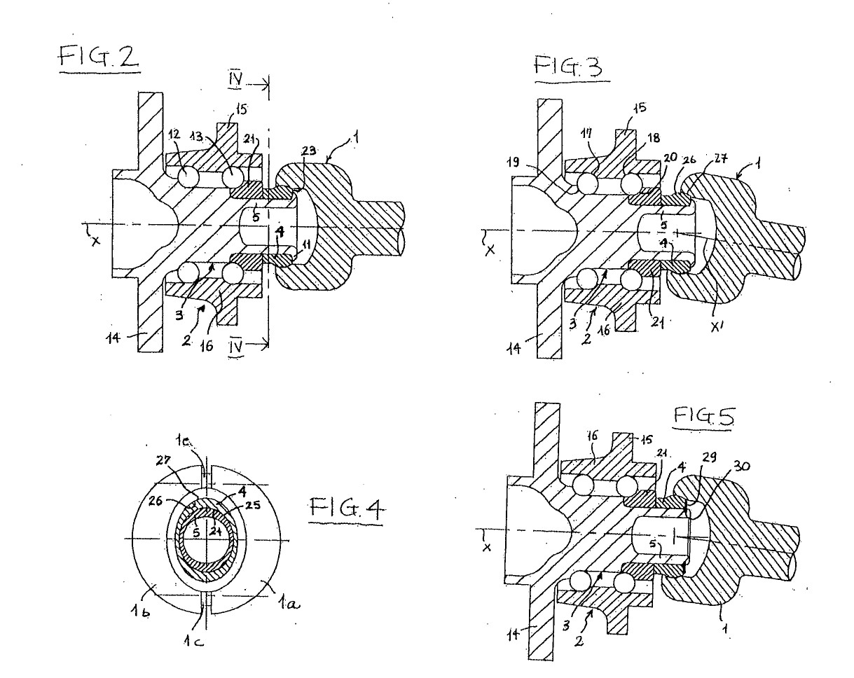

FIGS. 2 and 3 are two axial section views of a hub-homokinetic joint unit according to a first preferred form of embodiment of the present invention in two different operating conditions;

FIG. 4 is a radial section view according to the line IV-IV which is shown in FIG. 2;

FIG. 5 is an axial section view of a second preferred form of embodiment of the present invention;

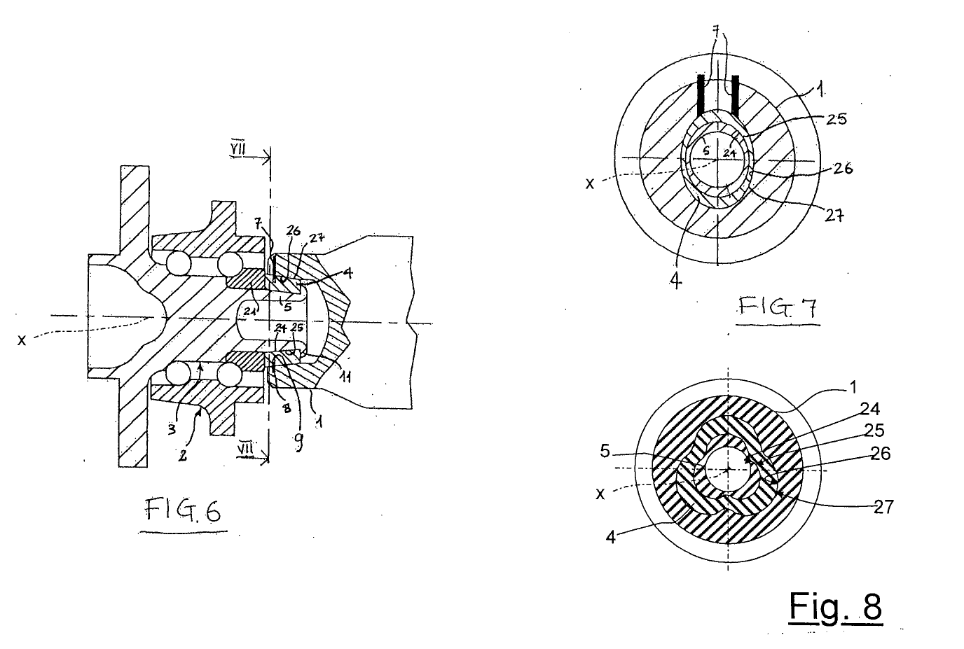

FIG. 6 is an axial section view of a third preferred form of embodiment of the present invention;

FIG. 7 is a radial section view according to the line VII-VII which is shown in FIG. 6; and

FIG. 8 is a radial section view of a fourth preferred form of embodiment of the present invention.

With reference to FIGS. 2 and 3, and using the same reference numbers in order to indicate the same or corresponding parts which have already been described with reference to FIG. 1, a hub 3 for a wheel of a motor vehicle is mounted in such a way that it can rotate around a rotation axis x of a suspension (which is not illustrated) of the vehicle by means of a bearing 2 with a double series of rolling elements 12 e 13, which in this example are spheres. The hub 3 is coupled in such a way as to rotate together with a homokinetic joint which is indicated with the number 1, according to methods which will be described in detail below.

The hub 3 forms on the axially inner side a tubular portion or spindle 5 which ends in an annular border 11, and on the axially outer side a radial flange 14 for mounting a wheel, which is not illustrated.

The hub 3-joint 1 unit is supported by a mount (which is not illustrated) of the suspension connected to a radial flange 15 of a fixed outer race 15 of the bearing 2. The spindle 5 axially projects beyond the axially inner end of the race 16, and is of a limited thickness in such a way that the annular border 11 may undergo cold deformation for rolling.

On the inner surface of the race 16 two external rolling tracks 17 and 18 are obtained for the two series of spheres 12 e 13, while the two corresponding inner tracks 19 e 20 are formed, one, directly on the hub 3 and, the other, on a separate race 21 which is shrink fit onto the spindle 5. According to possible variations, which are not illustrated, the spindle 5 may be hollow, and that is with a central cavity which opens at both the axial ends, and/or the inner tracks 19 and 20 may be formed on respective separate races and shrink fit onto the spindle of the hub.

On the inner axial end of the spindle 5, next to the race 21, there is an intermediate race 4 which is shrink fit in non-rotatable fashion and which serves for transmitting the driving torque from the joint 1 to the hub 3. In the examples which are shown in FIGS. 2 and 3, after the intermediate race 4 has been mounted on the spindle 5, the border 11 of the spindle is radially folded and tightly cold headed by plastic deformation, by means of rolling, against the radial wall 23 of the race 4. In this way, the race 4 is axially blocked on the hub 3, axially pre-loading the bearing-hub unit 2, 3.

With reference also to FIG. 4, the relative rotation between the race 4 and the hub 3 around the axis x is prevented by the congruent shape of the interface surfaces of these two surfaces, and that is the radially external surface 24 of the spindle and the radially internal surface 25 of the intermediate race 4. These interface surfaces 24 and 25 have the same smooth non-circular shape but with rounded lobes, preferably of a substantially spiral shape on a plane of radial or perpendicular section in relation to the rotation axis x of the hub. In similar fashion, the driving torque is transmitted from the homokinetic joint 1 to the intermediate race 4 thanks to the fact that the interface surfaces 26, 27 between these two transmitting bodies also have the same spiral shape, or congruent spiral shapes, on a plane of radial section.

In addition, as is illustrated in the examples shown in FIGS. 2 and 3, the radially external surface 26 of the intermediate race 4 and the radially internal surface 27 of the joint 1 are respectively convex and concave on a plane of axial section in order to permit a certain misalignment between the rotation axis x and of the hub and the rotation axis x′ of the drive shaft. The coupling of the surfaces 26 and 27 also ensures reciprocal axial blocking between the joint 1 and the intermediate race 4, without any need for additional blocking means. As is schematically illustrated in FIG. 4, the dome of the joint 1 is advantageously formed from the union of two halves 1a, 1b which are united by connecting means 1c in order to permit mounting on the intermediate race 4.

The variation which is illustrated in FIG. 5 differs from that which is shown in FIG. 1 due to the fact that the axial blocking of the intermediate race 4 on the hub is carried out by means of a seeger race 29 which is partially inserted inside a throat 30 formed on the end part of the spindle 5.

In the variations which are shown in FIGS. 6 and 7, the interface surfaces between the homokinetic joint, the intermediate race and the spindle of the hub comprise two pairs of facing surfaces 27, 26 and 25, 24 of a conical shape which tapers towards the axially internal side and spiral sections on a plane of radial or perpendicular section in relation to the rotation axis x of the hub, as is illustrated in FIG. 7. An elastic race 7, housed in two spiral throats 8 and 9 formed respectively on the homokinetic joint 1 and on the intermediate race 4, axially connects the latter to the homokinetic joint. The axial blocking of the intermediate race 4 may be obtained either by means of rolling the end border 11 of the spindle, or by means of an additional seeger race (like that which is indicated with the number 29 in FIG. 5), or by other means which are well known to experts in the field.

In the variations which are shown in FIGS. 6 and 7, the interface surfaces between the homokinetic joint, the intermediate race and the spindle of the hub comprise two pairs of facing surfaces 27, 26 and 25, 24 of a conical shape which tapers towards the axially internal side and spiral sections on a plane of radial or perpendicular section in relation to the rotation axis x of the hub .

In the variation which is shown in FIG. 8, the interface surfaces between the homokinetic joint, the intermediate race and the spindle of the hub comprise two pairs of facing surfaces 27, 26 and 25, 24 of a conical shape which tapers towards the axially internal side and presenting a radius R of angularly variable dimensions with continuity on a plane which is transverse to the axis x.

In particular, each pair of surfaces 27, 26 and 25, 24 comprises a number N1 of convex portions 50 in relation to the axis x, and a number N2 of concave portions 60 in relation to the axis A. The values of the numbers N1 and N2 depend on the necessary construction and planning characteristics, and may be equal to each other, as in cases of this kind, or different from each other. In particular, FIG. 8 illustrates a case in which both the number N1 and the number N2 have a value which is equal to three and the portions 50 and 60 are alternated in relation to each other around the axis x. Alternatively, and in a manner which may be easily understood from the foregoing description, the pairs of surfaces 27, 26 and 25, 24 may each be provided with only a single convex portion 50 which is arranged between two relative concave portions 60 contiguous in relation to each other.

In addition, although each pair of surfaces 27, 26 and 25, 24 follows, as shown in FIG. 8, the same law of variation of the radius R and has the same value for the numbers N1 and N2 as the other pair of surfaces 25, 24 and 27, 26, it is also possible to produce each pair of surfaces 27, 26 and 25, 24 with a value for the numbers N1 and N2 which is equal to or different from the value of the numbers N1 and N2 of the other pair of surfaces 25, 24 and 27, 26, as it is also possible to produce each pair of surfaces 27, 26 and 25, 24 with a conical shape in relation to the axis x of dimensions which are equal to or different from the conical shape of the pair of surfaces 25, 24 and 27, 26.

As can be appreciated, the present inventions eliminates the problems which are connected to the traditional ribbed couplings which were discussed in the introductory part of this description. The rounded lobe shape of the interface surfaces between the joint and the hub permit the uniform distribution of contact pressure over a wider area, thus avoiding peaks of tension. The assembly of the unit is simplified. Any eventual distortions caused by the final thermal treatment do not prejudice the coupling of the hub to the joint. In any case the rounded, broad shape of the interface surfaces simplifies any eventual mechanical finishing work. Such surfaces may be easily and precisely obtained by means of grinding a numerically controlled lathe and/or by means of grinding.

Naturally, while the principle of the present invention holds good, details pertaining to production and the forms of embodiment may be varied in relation to what has been herein described and illustrated, without in any way changing the context of the present invention. In particular, the above-described interface surfaces may be of an oval shape, similar to the shape of an egg and that is with a single non-circular lobe, or, as illustrated, of a spiral shape with two rounded lobes, or with three or more lobes.

1. Homokinetic joint-hub unit for a wheel of a motor vehicle, comprising:
a homokinetic joint (1),
a hub (3) which can rotate around a rotation axis (x) and which has an axially projecting spindle (5),
an intermediate race (4) which is fixed onto the spindle (5) in order to rotate with the homokinetic joint and transmit a driving torque of the joint (1) to the hub (3); the intermediate race (4) and the joint (1) being coupled in such a way as to rotate together around the rotation axis (x) by means of respective interface surfaces (26, 27) which have corresponding shapes on a plane which is perpendicular to the rotation (x)
wherein said interface surfaces (26, 27) have shapes which correspond to at least one smooth eccentric lobe in relation to the rotation axis (x).

2. Homokinetic joint-hub unit according to claim 1, wherein said interface surfaces (26, 27) have substantially corresponding spiral shapes with two smooth eccentric lobes in relation to the rotation axis (x).

3. Homokinetic joint-hub unit according to claim 1, wherein said interface surfaces (26, 27) have substantially corresponding oval shapes with at least only a single smooth eccentric lobe in relation to the rotation axis (x).

4. Homokinetic joint-hub unit according to claim 1, wherein said interface surfaces (26, 27) present a radius (R) of angularly variable dimensions with continuity on a plane which is transverse to the rotation axis (x), and comprise at least one respective convex portion (50) in relation to the rotation axis (x).

5. Homokinetic joint-hub unit according to claim 4, wherein said interface surfaces (26, 27) comprise, in relation to the rotation axis (x), a first determined number (N1) of convex portions (50) and a second determined number (N2) of concave portions (60).

6. Homokinetic joint-hub unit according to claim 5, wherein the first determined number (N1) of convex portions (50) and the second number (N2) of concave portions (6) coincide in relation to each other; the convex portions (50) being alternated around the rotation axis (x) in relation to the concave portions (60).

7. Homokinetic joint-hub unit according to claim 4, wherein said interface surfaces (26, 27) are conformed in a truncated cone shape in relation to the rotation axis (x).

8. Homokinetic joint-hub unit according to claim 1, wherein the said interface surfaces are respectively constituted by a radially external surface (26) of the intermediate race (4) and by a radially internal surface (27) of the joint (1), wherein the said interface surfaces (26, 27) are respectively convex (26) and concave (27) on a plane of axial section in order to permit misalignment between the rotation axis (x) of the hub and the rotation axis (x′) of the joint (1).

9. Homokinetic joint-hub unit according to claim 8, wherein the part of the joint (1) which forms said concave surface (27) is constituted by the union of two halves (1a, 1b) which are united by connecting means (1c) in order to permit mounting on the intermediate race (4).

10. Homokinetic joint-hub unit according to claim 1, in which said interface surfaces respectively comprise a radially external surface (26) of the intermediate race (4) and of a radially inner surface (27) of the joint (1), wherein said interface surfaces (26, 27) also have shapes which correspond substantially to non-circular cones and which taper towards the joint (1).

11. Bearing-hub unit for the wheel of a motor vehicle, comprising:
a bearing (2) with a double series of rolling elements (12, 13),
a hub (3) which is supported by the bearing (2) in such a way that it can rotate around a rotation axis (x) and having an axially projecting spindle (5),
an intermediate race (4) which is fixed on the spindle (5) and having a radially external surface (26) which constitutes an interface surface for coupling the hub, in such a way that it can rotate, to a corresponding interface surface (27) of a homokinetic joint (1)
wherein the radially external surface (26) of the intermediate race (4) forms at least one smooth eccentric lobe in relation to the rotation axis (x).

12. Bearing-hub unit according to claim 11, wherein the radially external surface (26) of the intermediate race (4) has a substantially spiral shape on a plane which is perpendicular to the rotation axis (x) with two smooth eccentric lobes in relation to the rotation axis (x).

13. Bearing-hub unit according to claim 12, wherein the radially external surface (26) of the intermediate race (4) has a substantially oval shape on a plane which is perpendicular to the rotation axis (x) with only a single smooth eccentric lobe in relation to the rotation axis (x).

14. Bearing-hub unit according to claim 13, wherein said interface surfaces (26, 27) present a radius (R) of angularly variable dimensions with continuity on a plane which is transverse to the rotation axis (x), and comprise at least one respective convex portion (50) in relation to the rotation axis (x).

15. Bearing-hub unit according to claim 14, wherein said interface surfaces (26, 27) comprise in relation to the rotation axis, a first determined number (N1) of convex portions (50) and a second determined number (N2) of concave portions (60).

16. Bearing-hub unit according to claim 15, wherein the first determined number (N1) of convex portions (50) and the second determined number (N2) of concave portions (60) coincide in relation to each other; the convex portions (50) being alternated around the rotation axis (x) in relation to the concave portions (60).

17. Bearing-hub unit according to claim 14, wherein said interface surfaces (26, 27) are conformed in accordance with a truncated cone shape in relation to the rotation axis (x).

18. Bearing-hub unit according to claim 14, wherein the radially external surface (26) of the intermediate race (4) is convex on a plane of axial section.

19. Bearing-hub unit according to claim 11, wherein the radially external surface (26) of the intermediate race (4) is substantially of a non-circular cone shape and tapers in a substantially internal axial direction.

20. Bearing-hub unit according to claim 11, wherein the spindle (5) and the intermediate race (4) are coupled in such a way as to rotate together around the rotation axis (x) by means of respective interface surfaces (24, 25) having shapes which correspond to at least one smooth eccentric lobe in relation to the rotation axis (x).

21. Bearing-hub unit according to claim 20, wherein said interface surfaces (24, 25) have corresponding substantially spiral shapes with two smooth eccentric lobes in relation to the rotation axis (x).

22. Bearing-hub unit according to claim 20, wherein said interface surfaces (24, 25) also have corresponding shapes which are substantially non-circular cones which taper in an axially internal direction.
